(19) United States
(12) Patent Application Publication
(10) Pub. No.: US 2013/0107396 A1
(43) Pub. Date: May 2, 2013

(54) VACUUM CLEARING OF SPINDLE PARTICULATES

(71) Applicant: Donald L. Ekhoff, Post Falls, ID (US)

(72) Inventor: Donald L. Ekhoff, Post Falls, ID (US)

(21) Appl. No.: 13/666,702

(22) Filed: Nov. 1, 2012

Related U.S. Application Data
(60) Provisional application No. 61/554,745, filed on Nov. 2, 2011.

(51) Int. Cl. G11B 33/14

(52) U.S. Cl. 360/97.13; G9B/33.042

(57) ABSTRACT

A vacuum scavenged spindle and disk clamp assembly decreases particulate contamination during testing and manufacturing of disks such as hard drive platters. A vacuum shroud is sealed to a casing and fitted to a clamp body attached to or integral with the spindle rotor, with the spindle rotor and the clamp body being rotatable. A first scavenging passageway pulls airflow from an interior region of the vacuum shroud, including particulates scavenged from the air bearing between the spindle rotor and the spindle stator. A second scavenging passageway extends from the interior region of the vacuum shroud through the clamp body to a hollow core of the disk clamp. A further scavenging passageway extends through the clamp body to a clamping region. Particulates from the spindle clamp are scavenged by airflow through the further scavenging passageway and the second scavenging passageway. A grounding brush may be attached to the vacuum shroud.

### CROSS-REFERENCE TO RELATED APPLICATION

This application claims priority from U.S. provisional application No. 61/554,745, filed Nov. 2, 2011.

### TECHNICAL FIELD

The field of the present disclosure relates to spindle assemblies and disk clamps as used in testing and manufacturing of disks such as magnetic platters used in computer hard drives.

### BACKGROUND

Testing and manufacturing of disks such as magnetically read and writable platters used in computer hard drives can generate particulates that contaminate the disks and the read or read write heads. With hard drive platters, the read write head flies above the surface of the disk and is susceptible to crashes caused by particulates. A conventional air bearing spindle and disk clamp assembly as used in manufacturing and testing of disks is shown in FIG. 1. The air bearing spindle and disk clamp assembly 100 includes an air bearing spindle assembly 102 and a disk clamp 104, each of which can be sources of particulates. Improvements are sought for decreasing the amount of contamination by particulates during testing and manufacturing of disks and thereby decreasing the likelihood of crashes or imperfections.

### SUMMARY

An air bearing spindle and disk clamp assembly is provided, having passageways extending to areas likely to need vacuum scavenging of particulates, such as to the assembly's disk clamp.

### BRIEF DESCRIPTION OF THE DRAWINGS

FIG. 1 is a cross-section view of a conventional air bearing spindle assembly and disk clamp.

FIG. 2 is a cross-section view of a vacuum-cleared air bearing spindle and disk clamp assembly in accordance with the present invention.

FIG. 3 is a cross-section view of a further embodiment of the vacuum-cleared air bearing spindle and disk clamp assembly of FIG. 2, with a grounding brush.

### DETAILED DESCRIPTION

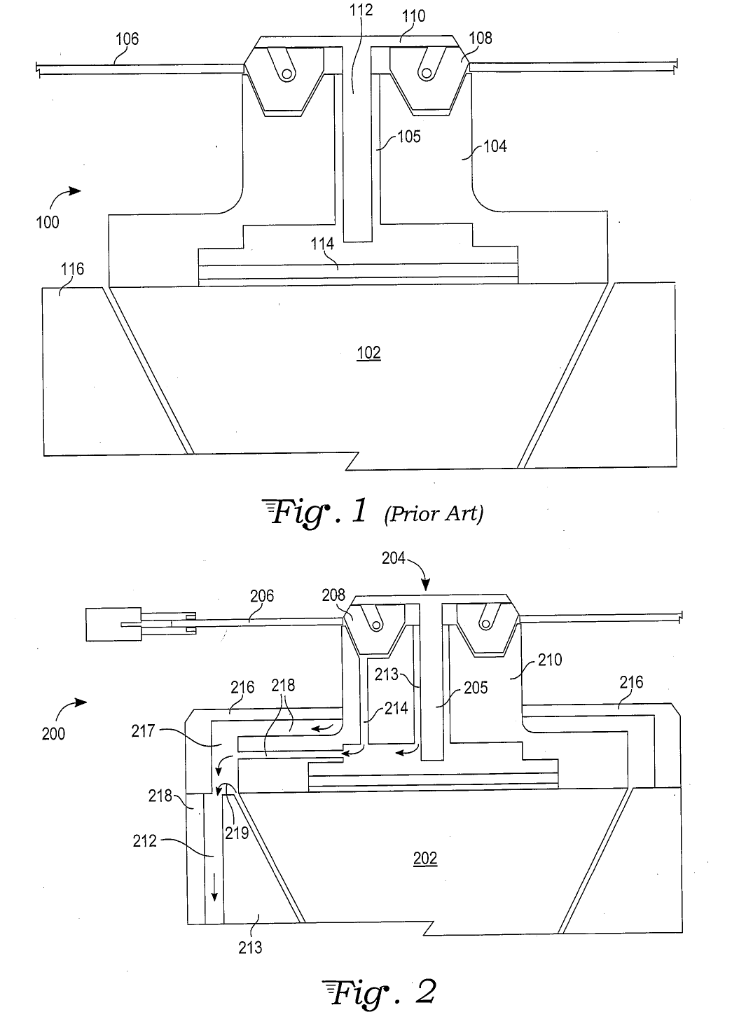

With reference to FIG. 2, an apparatus herein disclosed features vacuum clearing of particulates from a disk clamp 204 that holds a disk 206, such as a disk platter for a hard drive, to a spindle rotor 202 during manufacturing or testing. In the vacuum-cleared air bearing spindle and disk clamp assembly 200, vacuum scavenging (arrows) clears particulates from the clamping mechanism 204 that secures the platter or disk 206. The vacuum-cleared air bearing spindle and disk clamp assembly has a spindle air bearing 208 and may have a spindle clamp 210 with a flexing unitary jaw and radial control member as described in U.S. patent application Ser. No. 12/505,896 AXIAL FORCE SPINDLE CLAMP, or another spindle or clamping mechanism may be devised. A vacuum, applied to the disk clamp 210 via a passageway 212, is transferred to the disk clamping area by passageways 214 through the clamp body of the disk clamp internally connecting to the clamping mechanism 214. The applied vacuum scavenges particles from the clamping mechanism and the disk clamping area. In a further embodiment, additional passageways internally connect the applied vacuum to a region adjacent to the air bearing, so that the applied vacuum also scavenges particles from the air bearing.

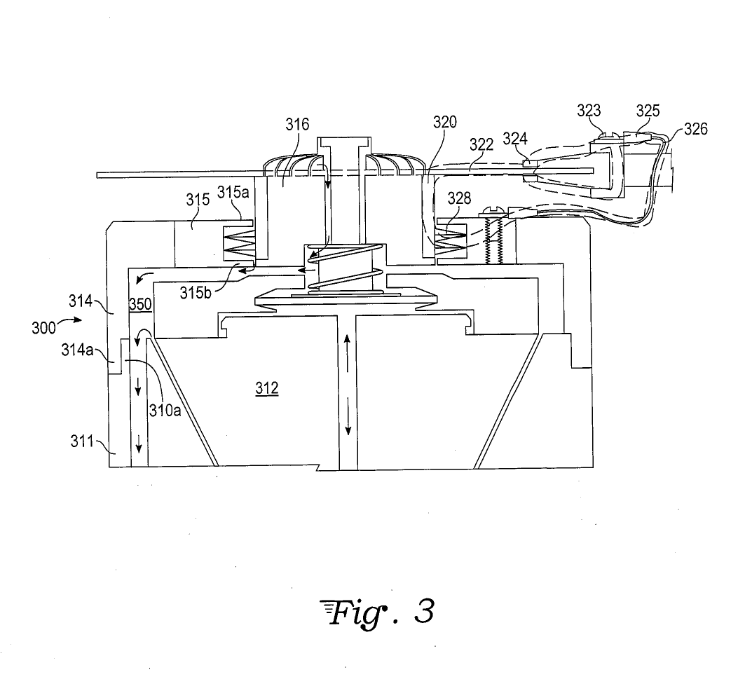

With reference to FIG. 1, a conventional air bearing spindle and disk clamp assembly 100 is shown, as suitable for use in manufacturing and testing of disks for disk drives, also known as hard drives. The conventional air bearing spindle and disk clamp assembly 100 has disk clamp 104 with a clamp body atop which sits a flat, circular disk 106, also known as a platter. The clamp body is attached to or is integral with the spindle rotor, i.e. the clamp body 104 and the spindle rotor 102 rotate together. A read write head (not shown, but see FIG. 3) is servo controlled and flies above the spinning disk, writing and reading data to and from the disk in a manner known in the art. Air or other gas, moving at or near the platter speed, acts as a type of air bearing and prevents the head or heads from contacting the disk.

Holding the disk 106 in place atop the clamp body 104 is a further portion of the disk clamp that includes a jaw set 108. The disk clamp further includes a metal cap 110 and an axial shaft 112. The axial shaft extends through a central orifice 105 in the clamp body 104, and is biased by a spring (not shown in FIGS. 1 and 2, but see FIG. 3). At the opposed end of the axial shaft from the metal cap, a piston is affixed, such as by a bolt, screw or other fastener or fastening method. A diaphragm 114 is immediately below the piston. The metal cap 110 holds the jaw set 108 in place, which in turn holds the disk 106 in place on the clamp body 104. A pneumatic clamp circuit built into the spindle air bearing activates and deactivates the spindle clamp. Air pressure in a central axial passageway through the main body of the rotor 102 presses upwards on the diaphragm 114, or a vacuum or low pressure pulls the diaphragm downwards, to activate or deactivate the spindle clamp. As is known in the art, the air pressure, vacuum or low pressure for operating the pneumatic clamp circuit can be provided by an “air gland” which can transfer pressurized air or vacuum efficiently and with little loss. In a further embodiment, the metal cap and the jaw set include a flex cap.

A two-piece spindle stator 116 includes an outer stator member having a casing and an inner stator member having stator windings. The spindle rotor 102, to which the clamp body 104 is attached or is integral, uses an air bearing and spins relative to the spindle stator 116, thus spinning the disk 106. Typically, an air bearing spindle is integrated into a piece of process equipment in a clean manufacturing environment so as to minimize particulate contamination to the air bearing at the time of integration.

Various moving parts are sources of particulates. At any time that two surfaces contact each other, particles can be knocked off and become free particulates. Over time, such action creates noticeable wear. The spinning spindle rotor 102 is a source of particulates, especially at startup when the spindle rotor is in partial to full contact with the spindle stator 116. Residual manufacturing contamination can also be released into the spindle rotor air bearing by the spindle rotor 102 or the spindle stator 116. Air or other gas circulation within a housing or chamber in which the disk and rotor are spinning can bring such particulate contaminants from the spindle rotor and spindle stator into the vicinity of the disk.

In an embodiment where the spindle clamp is moved for removal and replacement of disks, such as in testing and manufacture, the spindle clamp 104 is a source of particulates. The spindle clamp 104 is a mechanical clamping mechanism attached to the spindle rotor 102, and is used to grip a magnetic hard disk by the inside diameter of the disk 106. Such spindle clamps can be activated by air pressure, vacuum or a push bar extending through the spindle rotor connecting to an actuator at the rear of the spindle rotor, in various embodiments. Sliding and moving features on the spindle clamp cannot be lubricated, as a lubricant can be a contaminant. These sliding and moving features provide a particle source at the center of a spinning disk. Spinning motion of the disk causes such particles to move outward and contaminate various regions on the disk.

Returning to FIG. 2, improvements to the air bearing spindle and disk clamp assembly add vacuum scavenging of particulates, and include a vacuum shroud 216 and various low pressure passageways 214, 218, in the vacuum-cleared air bearing spindle and disk clamp assembly 200. The various scavenging passageways can be formed by drilling, machining, molding, casting or other known processes. The vacuum shroud 216 is sealed to the casing of the outer stator member 218, and further includes a noncontact vacuum seal to the clamp body 210 that allows the clamp body to rotate relative to the noncontact vacuum seal. Such a noncontact vacuum seal is achieved by closely fitting the vacuum shroud to the clamp body without contact thereto. This clearance fit assures that the vacuum shroud 216 does not make physical contact with the clamp body 210, and allows a small, controlled airflow to leak past the noncontact seal. The vacuum shroud 216 and the casing of the outer stator member 218 enclose the stator windings and the spindle rotor 202. A pneumatic evacuation circuit, separate from the pneumatic clamp circuit, provides vacuum or low pressure i.e. partial vacuum to the scavenging passageways.

A first scavenging passageway extends through the outer stator member 212, adjacent to the stator windings, and fluidly connects a source of low pressure or vacuum to an interior region of the vacuum shroud 216. The interior region 217 of the vacuum shroud collects airflow leaking past the vacuum seal of the vacuum shroud, flowing through the finite spacing between the vacuum shroud and the clamp body. Such airflow can include particulates created by the noncontact vacuum seal making inadvertent occasional contact with the clamp body, such as at startup of the spinning of the spindle or as a result of long-term wear. The interior region 217 of the vacuum shroud 216 further collects airflow 219 from the spindle air bearing, which can include particulates shed by the spindle rotor 202 or the spindle stator 213. The interior region 217 of the vacuum shroud 216 still further collects airflow from various further scavenging passageways 218, which can include particulates scavenged from the spindle clamp 210. The collected airflow and scavenged particulates are then directed out through the first scavenging passageway.

In one embodiment, the source of low pressure or vacuum is provided by a vacuum pump. The vacuum pump can be provided by the facility in a manner similar to the provision and availability of electrical power or compressed air. In a further embodiment the first scavenging passageway 212 includes or attaches to a filter, so that particulates are filtered out prior to the collected airflow passing into the source of low pressure or vacuum.

A second scavenging passageway 218 extends from an edge of the disk clamp, through the clamp body to a hollow core of the disk clamp, and fluidly connects the hollow core of the disk clamp to the interior region of the vacuum shroud. In one embodiment, multiple such second scavenging passageways 218 are employed, i.e. the disk clamp has multiple passageways through the clamp body 210 fluidly connecting the hollow core of the disk clamp to the interior region of the vacuum shroud. As the spindle rotor spins, airflow from the hollow core of the disk clamp is pulled into the interior region of the vacuum shroud, by the low pressure therein. In the embodiment shown, the second scavenging passageway extends through a base flange of the clamp body, and the base flange of the clamp body is bolted to the rotor.

A third scavenging passageway 213 is formed by the central orifice along a central axis through the clamp body through which the axial shaft 205 of the disk clamp extends. The third scavenging passageway 213 fluidly connects the clamping region of the disk clamp to the hollow core of the disk clamp. Airflow from the clamping region to the hollow core of the disk clamp captures particulates from the disk clamp and routes such particles out through the third scavenging passageway.

A fourth scavenging passageway 214 is displaced from and parallel to the third scavenging passageway 213, and extends from the hollow core of the disk clamp, through the clamp body to the clamping region of the disk clamp. The fourth scavenging passageway 214 fluidly connects the hollow core of the disk clamp to the clamping region of the disk clamp. Further airflow from the clamping region of the disk clamp captures particulates from the disk clamp, and is routed out through the fourth scavenging passageway. One embodiment has the third and fourth scavenging passageways, while a further embodiment has the third scavenging passageway and lacks the fourth scavenging passageway. A further embodiment has multiple such fourth scavenging passageways.

The low pressure or partial vacuum applied to the hollow core of the disk clamp provides a positive airflow from the jaw and clamping region inward towards the hollow core of the disk clamp. Particles created by actions of the disk clamp are captured in this airflow and routed out through the third and/or the fourth scavenging passageway.

The airflows passing through the third and fourth scavenging passageways combine in the hollow core of the disk clamp, and are pulled out through the second scavenging passageway or passageways and into the interior region of the vacuum shroud. From there, the airflow is pulled out through the first scavenging passageway. Thus, airflow out through the first scavenging passageway includes particulates scavenged from the air bearing of the spindle rotor, the noncontact vacuum seal of the vacuum shroud to the clamp body, and the disk clamp. Particulates from the air bearing of the spindle rotor and the vacuum seal of the vacuum shroud to the clamp body are scavenged via the interior region of the vacuum shroud. Particulates from the disk clamp are scavenged via the third and/or fourth scavenging passageways, as routed out through the second scavenging passageway or passageways to the interior region of the vacuum shroud.

With reference to FIG. 3, a brush-grounded vacuum scavenged air bearing spindle and disk clamp assembly 300 adds an electrical component to the vacuum scavenged air bearing spindle and disk clamp assembly 200 of FIG. 2. Historically, the known air bearing spindle and disk clamp assembly of FIG. 1 is grounded by way of a spring steel-equipped carbon button on the bottom of the rotating spindle. Debris from the rotating motion of the carbon button can form and get trapped under the carbon button, which adds resistance and upsets the read circuits in the read and write head. The trend towards smaller and denser magnetic domains in hard drive disks necessitates ever more sensitive read write heads and circuitry, which is more sensitive to noise.

With continuing reference to FIG. 3, a grounding brush 328, made of conductive microfibers which act as whiskers, is added to the air bearing spindle and disk clamp assembly 300. A carbide ring 320 is secured to the clamp body 316 of the disk clamp, and provides a hard seating surface upon which the disk 322 sits. The grounding brush 328 electrically and physically contacts the carbide ring 320, and maintains such contact as the spindle rotor 312 spins. Being conductive, the carbide ring electrically contacts the disk.

The grounding brush 328 is mounted to a holder, which is mounted to the vacuum shroud 314. A grounding wire 326 is attached to the read write head 324 or heads, and has a lug 325 that is attached to the grounding brush by a fastener 323, e.g. a screw or bolt. In this manner, the grounding wire 326 grounds the clamp body 316 and the spindle rotor 312 to the read write head 324 or heads. A small area electrical grounding loop is created by the electrical connection of the ground wire 326 to the read/write heads 324 in one direction and to the carbide ring 320 and the disk 322 in the opposite direction. A larger area electrical grounding loop is created in FIG. 1 by the longer path to the carbon button on the bottom of the rotating spindle rotor 312. The small area electrical grounding loop shown in FIG. 3 decreases the likelihood of electrical noise from a ground loop as compared to the larger area electrical grounding loop of FIG. 1.

A further advantage is gained by the small area electrical grounding loop shown in FIG. 3. The larger area electrical grounding loop in FIG. 1 may include known sources of electrical noise connected directly into the path. Equipment power supplies, motor drivers, positioning sensors, process electronics and other sources of electrical interference to the read/write heads may be connected into the path. Such sources, combined with the large area grounding loop, can cause signal loss and even permanent head damage in the case of electrostatic discharge (ESD). By contrast, the small area electrical grounding loop shown in FIG. 3 omits direct connections to such sources of electrical noise as equipment power supplies, motor drivers, positioning sensors and process electronics, and forms a much smaller closed-loop path which is less susceptible to electromagnetic interference.

However, the addition of the grounding brush creates a new source of particulates, which could be troublesome as a result of the proximity of this source to the disk and the read/write head. Raising the vacuum shroud 314 and arranging the mounting of the grounding brush 328 to the vacuum shroud 314, so that the particles generated by the contact of the grounding brush to the carbide ring 320 can be pulled away by an airflow into the interior region 350 of the vacuum shroud 314 and out through the first scavenging passageway, addresses the situation. In the embodiment shown, the grounding brush 328 is mounted in a cavity in the noncontact seal of the vacuum shroud 314, and the noncontact seal has a double-lip configuration with one lip 315a above and one lip 315b below the grounding brush 328. The vacuum shroud 314 fits tightly onto the outer stator member 311, such as by an interlocking inner and outer lip arrangement 310a, 314a. In one embodiment, a radial set screw in the vacuum shroud engages a conically shaped hole in the outer spindle stator member. Such an arrangement reduces the likelihood that the shroud could shift in fitment.

Particles generated by the contact of the grounding brush 328 to the carbide ring 320 are entrained in airflow leaking past the upper lip 315a of the double-lip noncontact seal, and are pulled by this airflow past the lower lip 315b of the double-lip noncontact seal. This airflow then passes into the interior region of the vacuum shroud 350, whereupon the airflow and particulates can be pulled out through the first scavenging passageway. In further embodiments, the grounding brush 328 is attached to the vacuum shroud 314 immediately adjacent to the noncontact seal or within the noncontact seal. Thus the brush-grounded vacuum scavenged air bearing spindle and disk clamp assembly 300 provides a reduced potential for ground loop noise and a reduced potential for particulate contamination as compared to the conventional air bearing spindle and disk clamp assembly 100. The brush-grounded vacuum scavenged air bearing spindle and disk clamp assembly 300 provides a reduced potential for ground loop noise and comparable reduced potential for particulate contamination as compared to the vacuum scavenged air bearing spindle and disk clamp assembly 200.

What is claimed is:

1. An air bearing spindle and disk clamp assembly comprising:
a spindle stator having an outer stator member with a casing and an inner stator member with windings;
a spindle rotor rotatable relative to the spindle stator and having an air bearing therebetween;
a disk clamp having a hollow core, a jaw and a clamp body attached to or integral with the spindle rotor, the disk clamp being operable such that the jaw can secure a disk so that the disk rotates with the spindle rotor;
a vacuum shroud sealed to the casing of the outer stator member and fitted to the clamp body such that the vacuum shroud and the casing enclose the stator windings and the spindle rotor, and the clamp body and the spindle rotor are rotatable relative to the vacuum shroud;
a first scavenging passageway extending through the outer stator member and fluidly connecting an interior region of the vacuum shroud to a source of low pressure or vacuum;
at least a second scavenging passageway extending through the clamp body and fluidly connecting the interior region of the vacuum shroud to the hollow core of the disk clamp; and
a further scavenging passageway extending through the clamp body and fluidly connecting the hollow core of the disk clamp to a clamping region at least partially occupied by the jaw of the disk clamp;
wherein particulates can be scavenged by an airflow through the further scavenging passageway and through the second scavenging passageway to the interior region of the vacuum shroud, from the air bearing to the interior region of the vacuum shroud and from the interior region of the vacuum shroud out through the first scavenging passageway as pulled by the source of low pressure or vacuum.

2. The air bearing spindle and disk clamp assembly of claim 1 wherein the further scavenging passageway includes a third scavenging passageway along a central axis of the clamp body, the third scavenging passageway further acting as a central orifice in the clamp body for an axial shaft connected to a cap.

3. The air bearing spindle and disk clamp assembly of claim 1 wherein the further scavenging passageway includes a fourth scavenging passageway through the clamp body and fluidly connecting the hollow core of the disk clamp to the clamping region, the fourth scavenging passageway being parallel to and displaced from a central axis of the clamp body.

4. An air bearing spindle and disk clamp assembly comprising:
a spindle stator having an outer stator member with a casing and an inner stator member with windings;
a spindle rotor rotatable relative to the spindle stator and having an air bearing therebetween;
a disk clamp having a hollow core, a jaw and a clamp body attached to or integral with the spindle rotor, the disk clamp being operable such that the jaw can secure a disk so that the disk rotates with the spindle rotor;
a conductive ring coaxially attached to or integral with the clamp body;
a vacuum shroud sealed to the casing of the outer stator member and having a noncontact seal to the clamp body such that the vacuum shroud and the casing enclose the stator windings and the spindle rotor, and the clamp body and the spindle rotor are rotatable relative to the vacuum shroud;
a grounding brush attached to the vacuum shroud proximate to or within the noncontact seal, physically and electrically contacting the conductive ring;
a first scavenging passageway extending through the outer stator member and fluidly connecting an interior region of the vacuum shroud to a source of low pressure or vacuum;
at least a second scavenging passageway extending through the disk clamp and fluidly connecting the interior region of the vacuum shroud to the hollow core of the disk clamp; and
a third scavenging passageway extending through the clamp body and fluidly connecting the hollow core of the disk clamp to a clamping region at least partially occupied by the jaw of the disk clamp;
wherein particulates can be scavenged by an airflow past the grounding brush and the noncontact seal to the interior region of the vacuum shroud, from the clamping region through the third scavenging passageway and through the second scavenging passageway to the interior region of the vacuum shroud, from the air bearing to the interior region of the vacuum shroud, and from the interior region of the vacuum shroud out through the first scavenging passageway as pulled by the source of low pressure or vacuum.

5. The air bearing spindle and disk clamp assembly of claim 4 wherein the third scavenging passageway acts as a central orifice in the clamp body for an axial shaft connected to a cap.
